(19) United States
(12) Patent Application Publication
(10) Pub. No.: US 2005/0235032 A1
(43) Pub. Date: Oct. 20, 2005

(54) System and method for haptic based conferencing

(76) Inventor: Wallace Robinson Mason III, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/825,061

(22) Filed: Apr. 15, 2004

(51) Int. Cl. G06F 15/16

(52) U.S. Cl. 709/204

(57) ABSTRACT

A system and method for conferencing is described. One embodiment comprises generating a first video signal, a first audio signal and a first haptic signal at a first location; generating a second video signal, a second audio signal and a second haptic signal at a second location; communicating the first video signal, the first audio signal and the first haptic signal to the second location; and communicating the second video signal, the second audio signal and the second haptic signal to the first location

### BACKGROUND

Audio and video conferencing systems allow two or more individuals to interactively communicate using both voice and video image communications. Such conferencing systems enable real-time audio and visual interaction between the users, much like a telephone provides real-time voice communications between users. That is, a first user (the receiver) hears sound and views the received video on a real-time basis as a microphone detects sound and a video camera captures video images at the location of a second user (the sender). Similarly, and concurrently, the second user (now a receiver) hears sound and views the other received video on a real-time basis as another microphone detects sound and another video camera captures images at the location of the first user (now a sender).

However, such audio and video conferencing systems are limited to communicating audio and video information. Although emotions of the sender can be perceived by the receiver through interpretation of voice inflections and facial expressions of the sender, the receiver cannot receive information that can be perceived by the sense of touch, referred to as tactile sensory perception.

### SUMMARY

A system and method for haptic based conferencing is described. One embodiment comprises generating a first video signal, a first audio signal and a first haptic signal at a first location, generating a second video signal, a second audio signal and a second haptic signal at a second location, communicating the first video signal, the first audio signal and the first haptic signal to the second location, and communicating the second video signal, the second audio signal and the second haptic signal to the first location.

### BRIEF DESCRIPTION OF THE DRAWINGS

The components in the drawings are not necessarily to scale relative to each other. Like reference numerals designate corresponding parts throughout the several views.

FIG. 1 illustrates an embodiment of an audio, video and haptic conferencing system.

FIG. 2 is an illustration of a user preparing to operate the haptic device used by an embodiment of the audio, video and haptic conferencing system.

FIG. 3 is an illustration of a user operating a transmitting haptic device used by an embodiment of the audio, video and haptic conferencing system.

FIG. 4 is an illustration of a receiving haptic device used by an embodiment of the audio, video and haptic conferencing system.

FIG. 5 is a block diagram illustrating in greater detail a portion of an embodiment of an audio, video and haptic conferencing system.

FIG. 6 is a flowchart illustrating an embodiment of a process used by an embodiment of an audio, video and haptic conferencing system.

### DETAILED DESCRIPTION

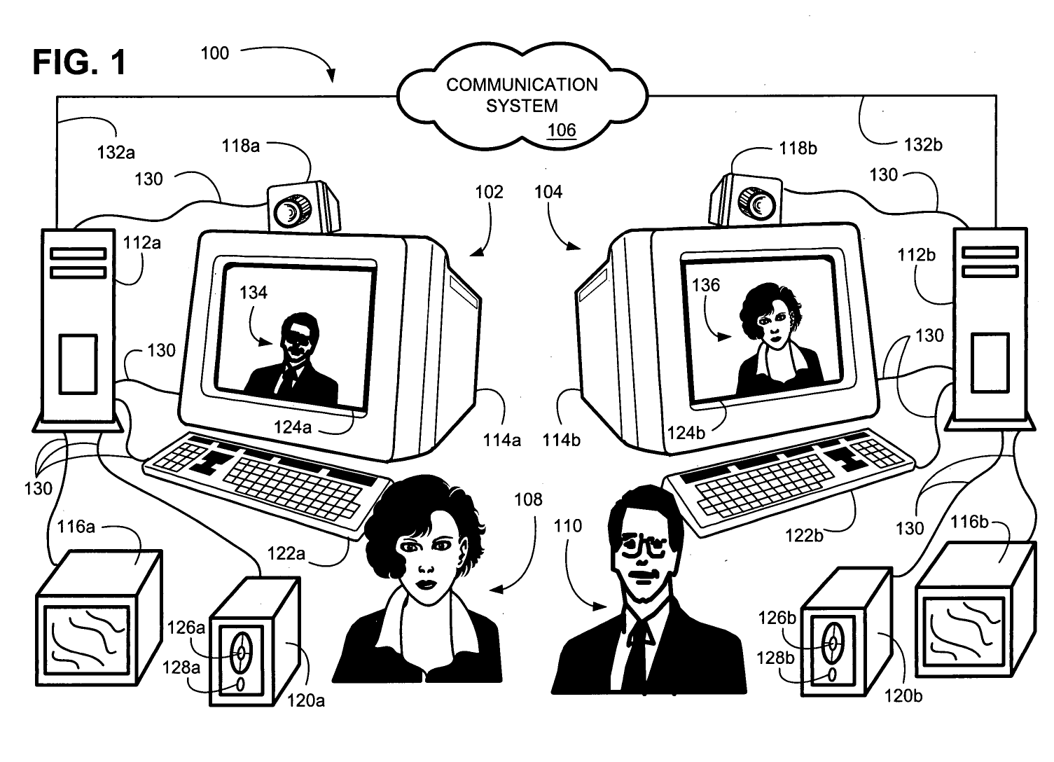

FIG. 1 illustrates an embodiment of a haptic based conferencing system 100. To support audio, video and haptic conferencing, at least a first audio, video and haptic conferencing system 102 and a second audio, video and haptic conferencing system 104 are required, referred to hereinafter as the first conferencing system 102 and the second conferencing system 104 for convenience. The first conferencing system 102 and the second conferencing system 104 are in communication with each other via communication system 106. The user 108 using the first conferencing system 102 (at a first location) is able to hear, view and sense tactile communications from the second user 110 (at a second location) using the second conferencing system 104. Similarly, the second user 110 using the second conferencing system 104 is able to hear, view and sense tactile communications from the user 108 using the first conferencing system 102.

For convenience, an embodiment of the audio, video and haptic based conferencing system 100 is described and illustrated using the two conferencing systems 102 and 104. However, it is understood that additional audio, video and haptic conferencing systems may be concurrently in communication with the conferencing systems 102 and 104, thereby supporting concurrent voice, video and tactile communications between a plurality of users.

The first conferencing system 102 comprises a processing device 112a, a display 114a, a haptic device 116a, a video image capture device 118a, an audio device 120a and an optional keyboard 122a. Similarly, the second conferencing system 104 comprises a processing device 112b, a display 114b, a haptic device 116b, a video image capture device 118b, an audio device 120b and an optional keyboard 122b.

Displays 114a/b include a view screen 124a/b, respectively. View screens 124a/b may be any suitable device for displaying an image corresponding to a received video signal. For example, but not limited to, view screens 124a/b may be a cathode ray tube (CRT), a flat panel screen, a light emitting diode (LED) screen, liquid crystal display (LCD) or any other display device.

Audio devices 120a/b are audio input/output devices, and comprise a speaker 126a/b that generates audio sounds (from received audio signals) and a microphone 128a/b that detects audio sounds (to generate audio signals). They may be separate devices (an audio input device and an audio output device), or they may have both input and output functions combined into a single device.

For convenience, the video image capture devices 118a/b are referred to hereinafter as a video camera that generates a video signal, and is understood to be any suitable image capture device configured to successively capture and communicate a streaming plurality of images, referred to as a video for convenience, on a real-time basis. Also, the video cameras 118a/b are illustrated as residing on top of the displays 114a/b. Video cameras 118a/b may be located in any suitable location.

Typically, keyboards 122a/b are used to receive operating instructions from the users 108 and 110, respectively. However, other embodiments employ other suitable input devices. In another embodiment, no input device is required.

Processing devices 112a/b are suitable processing devices configured to support audio, video and haptic conferencing. Processing devices may be special devices limited to support audio, video and haptic conferencing, or may be multi-purpose devices. For example, but not limited to, embodiments of the processing devices may be implemented as a personal computer, a laptop, a personal communication device or a cellular communication device. Furthermore, the displays 114a/b, haptic devices 116a/b, video cameras 118a/b, audio devices 120a/b and the optional keyboards 122a/b are illustrated for convenience as separate devices communicatively coupled to their respective processor via connections 130. It is understood that one or more of these devices may be combined into an integrated device.

The connections 130 are illustrated as physical-wire connections for convenience. It is understood that alternative embodiments may employ other suitable communication media other than the illustrated physical-wire connections 130, such as, but not limited to, a radio frequency (RF) wireless medium, an infrared medium, an optical medium or the like.

When users 108 and 110 are in an audio, video and haptic conferencing session, video cameras 118a/b capture images of their respective users 108/110, and communicate the captured images, through communication system 106, to the receiving display 114b/a. The microphones 128a/b detect audio information, such as voice communications from their respective users 108/110, and communicates the detected audio information, through communication system 106, to the receiving speakers 126b/a. The receiving speakers 126b/a then generate audible sound so that its respective user 110/108 can hear the sounds detected by the microphones 128a/b, respectively. Haptic devices 116a/b communicate tactile information, through communication system 106. Communication of tactile information is described in greater detail hereinbelow. Accordingly, user 108 can view the user 110 on display 114a, hear the voice of user 110 from audible sound generated by speaker 128a, and receive tactile information (by touching the haptic image generated by the haptic device 118a) from the user 110. Similarly, and concurrently, user 110 can view the user 108 on display 114b, hear the voice of user 108 from audible sound generated by speaker 128b, and receive tactile information (by touching the haptic image generated by the haptic device 118b) from the user 108.

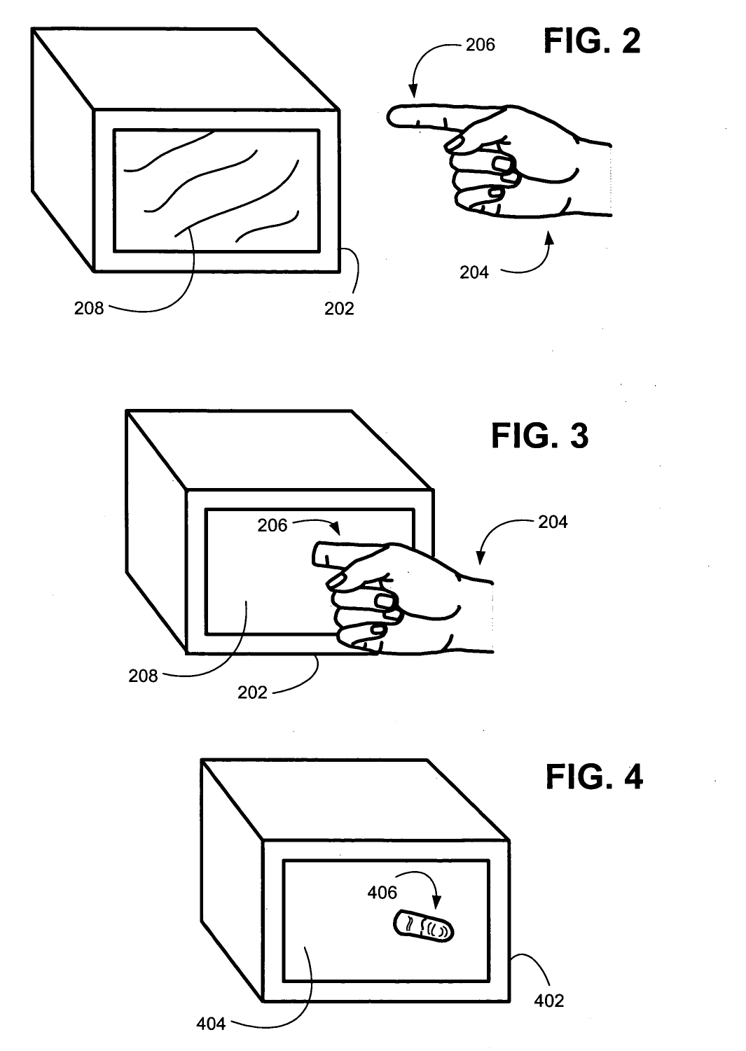

FIG. 2 is an illustration of a hand 204 of one of the users 108 or 110 (FIG. 1) preparing to operate a sending haptic device 202 used by an embodiment of the audio, video and haptic based conferencing system 100 (FIG. 1). The user's hand 204 is illustrated for convenience with the index finger 206 outwardly extended.

Haptic device 202 is illustrated as a box-like device for convenience. One embodiment of the haptic device 202 includes an optional flexible membrane 208 covering the tactical sensing region of the haptic device 202. Haptic devices 202 are known in the art as devices that detect tactile (physical) forces and/or physical displacement, such as the force exerted by a finger and the corresponding displacement of the flexible membrane 208 resulting from the force exerted by the finger (or other object in contact with the flexible membrane 208). The detected force and/or displacement is converted into a corresponding electrical signal. This electrical signal, referred to herein as a haptic signal for convenience, can then be communicated to other haptic based devices, as described in greater detail herein.

One embodiment of the haptic device 202 employs a matrix of parallel oriented pins (not shown) located beneath the optional flexible membrane 208. As forces are exerted on the flexible membrane 208 and a corresponding displacement of the flexible membrane 208 occurs, the position of the pins in the matrix change. Position detectors associated with the pins detect displacement (movement) of the pins. In one embodiment, force sensors associated with the pins detect force exerted on the pins.

Other types of haptic devices employ other means configured to detect displacement and/or force. Such devices may use bladders wherein changes in the amount of fluid in the bladder corresponds to displacement, and wherein fluid pressure in the bladder corresponds to exerted force. Other haptic devices may employ skeleton structures that detect force and/or displacement. Some haptic devices are configured to detect forces and/or displacements on skeleton members in three dimensions, known as digital clay. It is understood that any suitable haptic device, now known or later developed, may be employed by various embodiments of the audio, video and haptic based conferencing system 100. Accordingly, for brevity and convenience, such haptic devices need not be disclosed in great detail other than to the extent that such haptic devices 116 and/or 202 (FIGS. 1-3) are configured to detect displacement and/or force, and are configured to generate a haptic signal corresponding to the detected displacement and/or force.

FIG. 3 is an illustration of a user operating a sending haptic device 202 used by an embodiment of the audio, video and haptic based conferencing system 100. In this figure, the user has “pushed” a portion of their index finger 206 into the haptic device 202. That is, the user has exerted a force with their index finger 206 onto the flexible membrane 208, thereby causing the flexible membrane 208 to be displaced in an inward direction. This inward displacement is detected, converted into a haptic signal corresponding to the detected displacement, and then is communicated from the haptic device 202. Accordingly, it appears that a portion of the index finger 206 is inside the haptic device 202.

In another embodiment, the sending haptic device 202 additionally detects force exerted upon the flexible membrane caused when index finger 206 is “pushed” onto the flexible membrane 208. As this force is detected, a haptic signal is generated that contains information corresponding to the detected force. This force information may be combined with the above-described displacement information into a single haptic signal or may be communicated as a separate haptic signal from the sending haptic device 202. Accordingly, a corresponding force will be associated with the haptic image of the index finger displayed by the receiving haptic device 402, described below.

FIG. 4 is an illustration of a receiving haptic device 402 used by an embodiment of the audio, video and haptic based conferencing system 100. The receiving haptic device 402 is configured to receive a haptic signal corresponding to the above-described haptic signal generated by the sending haptic device 202 (FIGS. 2 and 3). The receiving haptic device 402 actuates an internal mechanism (not shown) that exerts a force against the flexible membrane 404, thereby resulting in an outward displacement of the flexible membrane 404. This outward displacement corresponds to the above-described inward displacement detected by the sending haptic device 202. In the simplified example of FIGS. 2-4, wherein the user has pushed a portion of their index finger 206 (FIGS. 2 and 3) into the haptic device 202, the outward displacement resembles that portion of the index finger 206. That is, the receiving haptic device causes a physical image 406 of the inserted portion of index finger 206 to appear on the flexible membrane 404. For convenience, the resulting physical image 406 is referred to herein interchangeably as a haptic image.

Such receiving haptic devices 402 are known in the art as devices that reproduce physical displacement and/or tactile (physical) forces. The reproduced displacement and/or force is based upon a received haptic signal. One embodiment of the haptic device 402 employs a matrix of parallel oriented pins (not shown) located beneath the flexible membrane 404. As forces are exerted on the flexible membrane 404 by the pins, a corresponding displacement of the flexible membrane 404 occurs. Position detectors associated with the pins specify displacement (movement) of the pins. Force sensors associated with the pins may reproduce a force that is exerted on the pins. As noted hereinabove, one embodiment of a haptic signal contains both displacement information and force information. Another embodiment employs a first haptic signal with displacement information and a second haptic signal with force information. Such embodiments may combine the displacement information and/or force information with the audio and/or video information into a single signal.

Other types of receiving haptic devices 402 employ other means configured to reproduce displacement and/or force. Such devices may use bladders wherein changes in the amount of fluid in the bladder corresponds to displacement, and wherein fluid pressure in the bladder corresponds to exerted force. Other haptic devices may employ skeleton structures that reproduce displacement and/or force. Some haptic devices are configured to reproduce (exert) displacements and/or forces on skeleton members in three dimensions. It is understood that any suitable haptic device, now known or later developed, may be employed by various embodiments of the audio, video and haptic based conferencing system 100. Accordingly, for brevity and convenience, such receiving haptic devices need not be disclosed in great detail other than to the extent that such haptic devices 402 are configured to reproduce displacement and/or force based upon a received haptic signal corresponding to the detected displacement and/or force by another haptic device.

In one embodiment, the above-described displacement and/or force reproduced by the receiving haptic device 402 are the same or substantially the same as the detected displacement and/or force of the sending haptic device 202. In alternative embodiments, the reproduced displacement and/or force is proportional to the detected displacement and/or force.

In one embodiment, the haptic devices 116a and 116b (FIG. 1) are responsive to each other. That is, when forces are exerted simultaneously on the haptic devices 116a/b, the forces are integrated together. Accordingly, such integration more realistically reproduces tactile sensation to the user when an integrated haptic image is produced by the haptic devices 116a/b. For example, such an embodiment would enable remotely located users to shake hands with each other, such that each user could sense the forces exerted by the other during the handshake.

A first haptic signal is received from a first haptic device. Concurrently, a second haptic signal is received from a second haptic device. Both haptic signals comprise information corresponding to displacement and exerted force. Displacement information and exerted force information for the two haptic signals are integrated into an integrated haptic signal.

In one embodiment, the integrated haptic signal is communicated back to both the first and the second haptic devices. In another embodiment, integration of the haptic signals is concurrently performed at the first location and at the second location.

The first and second haptic devices then reproduce an integrated haptic image based upon the integrated haptic signal. Accordingly, the users of the first haptic device and the second haptic device perceive tactile sensory information that is comprised both of their force and displacement exerted on their haptic device, and the force and displacement exerted on the other haptic device by the other user. An illustrative embodiment of such haptic devices responsive to each other is disclosed in U.S. Pat. No. 6,639,582 B1 to Shrader, incorporated in its entirety herein by reference.

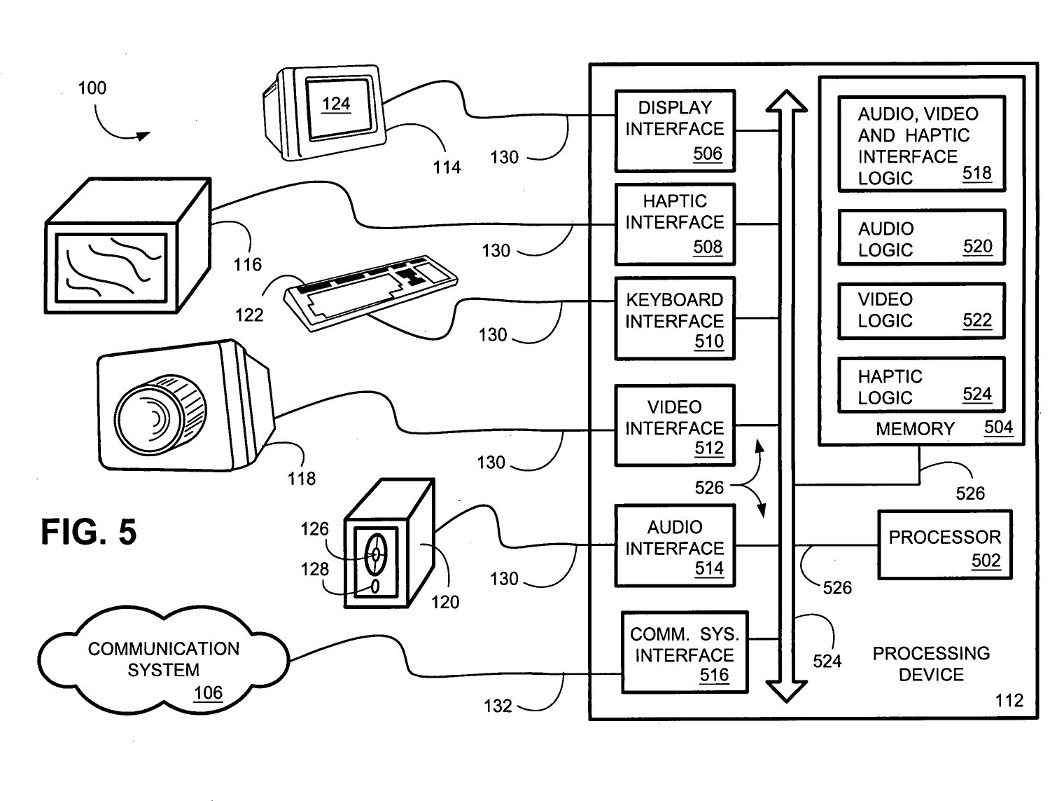

FIG. 5 is a block diagram illustrating in greater detail a portion of an embodiment of an audio, video and haptic based conferencing system 100. Components in FIG. 5 that correspond to components illustrated in FIG. 1 are identified by like reference numbers with the “a” or “b” omitted. For example, the display 114a and the display 114b of FIG. 1 correspond to the display 114 of FIG. 5. It is understood that the components illustrated in FIG. 1, and as generally illustrated in FIG. 5, need not be identical to each other, but rather, such components have similar functionality.

Processing device 112 comprises a processor 502, a memory 504 and a plurality of interfaces that are configured to communicatively couple the above-described components to the processing device 112. In the exemplary embodiment of processing device 112, display interface 506 provides coupling to the display 114, haptic interface 508 provides coupling to the haptic device 116, keyboard interface 510 provides coupling to the optional keyboard 122, video interface 512 provides coupling to the video camera 118, audio interface 514 provides coupling to the audio device 120 and communication system interface 516 provides coupling to the communication system 106.

Memory 504 includes regions for the audio, video and haptic interface logic 518, audio logic 520, video logic 522 and haptic logic 524. Audio logic 520 and video logic 522 comprise executable code that supports audio and video conferencing between the users 108 and 110 (FIG. 1). Haptic logic 524 comprises executable code that supports the above described haptic communications between the haptic devices 116a and 116b (FIG. 1). That is, the haptic logic 524 receives a haptic signal from a sending haptic device that corresponds to detected displacement and/or force, and/or transmits a haptic signal to a receiving haptic device that corresponds to displacement and/or force detected by another haptic device. In some embodiments, received and transmitted signals are integrated together such that an integrated haptic signal corresponding to detected displacement and/or force is integrated, with the integrated haptic signal being transmitted to each haptic device for reproduction as a haptic image as described herein.

The audio, video and haptic interface logic 518 comprises executable code that supports the above communication of the video conferencing functions (audio and visual perception) and the haptic functions (tactile perception) on a real-time basis. In one embodiment, the communicated video conferencing signal (an audio signal and a video signal) is combined with the haptic signal into a single integrated haptic and video conferencing signal. In another embodiment, separate video, audio and/or haptic signals are communicated in a coordinated fashion such that the users 108 and 110 perceive video, audio and haptic communications on a real-time basis.

The above-described interfaces are illustrated for convenience as interfaces designed to communicatively couple their respective device using physical connectors 130 and 132. As noted above, other communication media may be employed by other embodiments. For example, interfaces and/or devices may employ a RF medium for communication. Accordingly, one embodiment of the haptic interface 508 may be configured to receive and transmit RF signals to the haptic device 116, which itself incorporates a suitable RF transceiver. It is understood that the nature of the interface depends upon the communication media design, and accordingly, any suitable communication media may be employed by embodiments of an audio, video and haptic based conferencing system 100.

Communication system 106 is illustrated as a generic communication system. In one embodiment, communication system 106 comprises the internet and a telephony system. Accordingly, the communication system interface 516 is a suitable modem. Alternatively, communication system 106 may be a telephony system, a radio frequency (RF) wireless system, a microwave communication system, a fiber optics system, an intranet system, a local access network (LAN) system, an Ethernet system, a cable system, a radio frequency system, a cellular system, an infrared system, a satellite system, or a hybrid communication system comprised of two or more of the above-described types of communication media.

The above-described processor 502, memory 504 and interfaces are communicatively coupled to communication bus 524, via connections 526. In alternative embodiments of processing device 112, the above-described components are connectivley coupled to processor 502 in a different manner than illustrated in FIG. 5. For example, one or more of the above-described components may be directly coupled to processor 502 or may be coupled to processor 502 via intermediary components (not shown).

For convenience, the audio, video and haptic interface logic 518, audio logic 520, video logic 522 and haptic logic 524 were illustrated as separate logic. In other embodiments, two or more of the audio, video and haptic interface logic 518, audio logic 520, video logic 522 and haptic logic 524 may be implemented as a single, integrated logic. For example, one embodiment may be a single logic that supports audio, video and haptic conferencing functionality. Another embodiment may be configured to operate separately with an existing audio and video logic unit, thereby providing the expanded capability of haptic conferencing. In yet another embodiment, the haptic logic function and the associated haptic conferencing function may be implemented as an upgrade to a pre-existing audio and video logic unit.

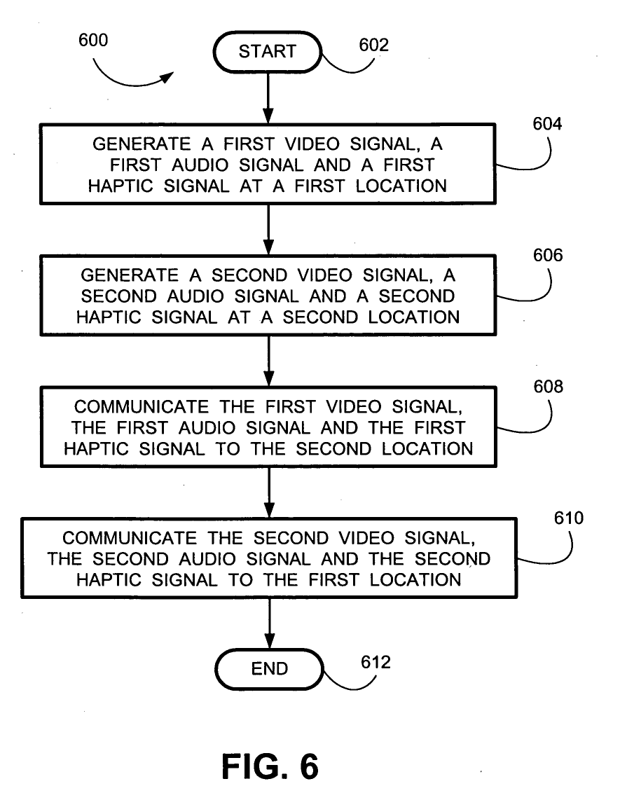

FIG. 6 shows a flow chart 600, according to the present invention, illustrating an embodiment of an audio, video and haptic based conferencing system 100 (FIG. 1). The flow chart 600 of FIG. 6 shows the architecture, functionality, and operation of an embodiment for implementing the audio, video and haptic interface logic 518, audio logic 520, video logic 522 and haptic logic 524 (FIG. 5) such that audio, video and haptic conferencing is supported as described herein. An alternative embodiment implements the logic of flow chart 600 with hardware configured as a state machine. In this regard, each block may represent a module, segment or portion of code, which comprises one or more executable instructions for implementing the specified logical function(s). It should also be noted that in some alternative implementations, the functions noted in the blocks may occur out of the order noted in FIG. 6, or may include additional functions. For example, two blocks shown in succession in FIG. 6 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of the present invention

The process begins at block 602. At block 604, a first video signal, a first audio signal and a first haptic signal are generated at a first location. At block 606, a second video signal, a second audio signal and a second haptic signal are generated at a second location. At block 608, the first video signal, the first audio signal and the first haptic signal are communicated to the second location. At block 610, the second video signal, the second audio signal and the second haptic signal are communicated to the first location. The process ends at block 612.

Another exemplary use of the audio, video and haptic based conferencing system 100 is to convey information, during a conferencing session, about an object of interest. During the conferencing session the object of interest may be pressed into the sending haptic device. The sending haptic device would communicate a haptic signal to a receiving haptic device. The receiving haptic device would reproduce a haptic image corresponding to the object of interest based upon a received haptic signal.

During the conferencing session, the users could view and discuss the object of interest using the audio and video components of the audio, video and haptic based conferencing system 100. The receiving user could then visually and tactically perceive information regarding the object of interest from the receiving haptic device. For example, the receiving user may make measurements of the reproduced haptic image, thereby indirectly making measurements of the object of interest.

In another embodiment, the sending and receiving haptic devices may be relatively large devices. For example, but not limited to, the sending and receiving haptic devices may be large enough to accommodate all or a portion of a person. In an instance where the person may desire to purchase a suit or other article of clothing, the person could enter the sending haptic device, thereby generating a haptic signal corresponding to all of or a portion of the person's body. The tailor using the receiving haptic device could then measure the reproduced haptic image, thereby indirectly making measurements of the person. During the conferencing session, the person, tailor and/or other parties could view and discuss the suit or article of clothing using the audio and video components of the audio, video and haptic based conferencing system 100.

Embodiments of above-described system or methodology that are implemented in memory 504 (FIG. 5) may be implemented using any suitable computer-readable medium. In the context of this specification, a “computer-readable medium” can be any means that can store, communicate, propagate, or transport the data associated with, used by or in connection with the instruction execution system, apparatus, and/or device. The computer-readable medium can be, for example, but not limited to, an electronic, magnetic, optical, electromagnetic, infrared, or semiconductor system, apparatus, device, or propagation medium now known or later developed.

It should be emphasized that the above-described embodiments are merely examples of implementations. Many variations and modifications may be made to the above-described embodiments. All such modifications and variations are intended to be included herein within the scope of this disclosure and protected by the following claims, except insofar as limited by express claim language or the prior art.

1. A method for conferencing, the method comprising:
generating a first video signal, a first audio signal and a first haptic signal at a first location;
generating a second video signal, a second audio signal and a second haptic signal at a second location;
communicating the first video signal, the first audio signal and the first haptic signal to the second location; and
communicating the second video signal, the second audio signal and the second haptic signal to the first location.

2. The method of claim 1, wherein communicating to the first location is concurrently performed with communicating to the second location.

3. The method of claim 1, further comprising:
generating an audible sound at the first location, the audible sound corresponding to the second audio signal;
displaying a video at the first location, the video corresponding to the second video signal; and
reproducing a haptic image at the first location, the haptic image corresponding to the second haptic signal.

4. The method of claim 1, further comprising:
generating an audible sound at the second location, the audible sound corresponding to the first audio signal;
displaying a video at the second location, the video corresponding to the first video signal; and
reproducing a haptic image at the second location, the haptic image corresponding to the first haptic signal.

5. The method of claim 1, further comprising the steps of:
integrating the first video signal, the first audio signal and the first haptic signal into a first integrated signal;
integrating the second video signal, the second audio signal and the second haptic signal into a second integrated signal; and
concurrently communicating the first integrated signal to the second location and communicating the second, integrated signal to the first location.

6. The method of claim 5, further comprising the steps of:
generating an integrated haptic signal from the first integrated signal and the second integrated signal;
reproducing an integrated haptic image corresponding to the integrated haptic signal at the first location; and
concurrently reproducing the integrated haptic image at the second location.

7. A conferencing system comprising:
a video camera at a first location configured to capture video and communicate the video to a second location;
a display at the second location configured to receive and display the communicated video;
an audio input device at the first location configured to capture audio and communicate the captured audio to the second location;
an audio output device at the second location configured to receive and reproduce the communicated audio;
a first haptic device at the first location configured to generate a haptic signal to communicate the haptic signal to the second location; and
a second haptic device at the second location configured to receive the haptic signal and produce a haptic image corresponding to the communicated haptic signal.

8. The conferencing system of claim 7, wherein the first haptic device is further configured to detect an object, and wherein the communicated haptic signal corresponds to the detected object.

9. The conferencing system of claim 8, wherein the first haptic device is further configured to detect a force exerted by the object, and wherein the communicated haptic signal further corresponds to the detected force.

10. The conferencing system of claim 8, wherein the second haptic device is configured to detect a second object, and wherein the communicated haptic signal corresponds to integration of the detected objects.

11. The conferencing system of claim 10, wherein the first haptic device is further configured to detect a force exerted by the object, wherein the second haptic device is further configured to detect a second force exerted by the second object, and wherein the communicated haptic signal corresponds to integration of the detected forces.

12. The conferencing system of claim 7, further comprising a processor configured to integrate the communicated video, audio and haptic signal into an integrated signal that is communicated to the second location.

13. The conferencing system of claim 7, further comprising:
a second video camera at the second location configured to capture a second video and communicate the second video to the first location;
a second display at the first location configured to receive and display the second video;
a second audio input device at the second location configured to detect a second audio and communicate the detected second audio to the first location; and
a second audio output device at the first location configured to receive and reproduce the communicated second audio.

14. A system providing conferencing signals, comprising:
a first conferencing signal originating at a first location, the first conferencing signal comprising:
an audio portion corresponding to sound detected by an audio detection device at the first location;
a video portion corresponding to a video generated by a first camera at the first location; and
a haptic portion corresponding to a haptic signal generated by a haptic device at the first location;
a second conferencing signal originating at a second location, the second conferencing signal comprising:
a second audio portion corresponding to other sounds detected by a second audio detection device at the second location;
a second video portion corresponding to a second video generated by a second camera at the second location; and
a second haptic portion corresponding to a second haptic signal generated by a second haptic device at the second location; and
a communication system configured to communicate the first conferencing signal to the second location and configured to communicate the second conferencing signal to the first location.

15. The system of claim 14, wherein the communication system comprises at least one of an internet system, a telephony system, a radio frequency (RF) wireless system, a microwave communication system, a fiber optics system, an intranet system, a local access network (LAN) system, an Ethernet system, a cable system, a radio frequency system, a cellular system, an infrared system and a satellite system.

16. A conferencing system, comprising:
means for communicating a first conferencing signal to a first location, the first conferencing signal comprising a first video signal, a first audio signal and a first haptic signal each generated at a second location;
means for communicating a second conferencing signal to the second location, the second conferencing signal comprising a second video signal, a second audio signal and a second haptic signal each generated at the first location;
means for displaying the first video signal and the second video signal;
means for reproducing the first audio signal and the second audio signal; and
means for reproducing the first haptic signal and the second haptic signal.

17. The system of claim 16, further comprising:
means for receiving a second communication signal at the second location, the second communication signal comprising a second video signal, a second audio signal and a second haptic signal each generated at the first location;
means for displaying the second video signal as a second video;
means for reproducing the second audio signal as a second audible sound;
means for reproducing the second haptic signal as a second haptic image.

18. The conferencing system of claim 17, further comprising:
means for integrating the first haptic signal and the second haptic signal into an integrated haptic signal;
means for reproducing an integrated haptic image corresponding to the integrated haptic signal at the first location; and
means for concurrently reproducing the integrated haptic image at the second location.

19. A program for video and haptic conferencing stored on a computer-readable medium, the program comprising:
logic configured to communicate a first conferencing signal to a first location, the first conferencing signal comprising a first video signal, a first audio signal and a first haptic signal each generated at a second location;
logic configured to communicate a second conferencing signal to the second location, the second conferencing signal comprising a second video signal, a second audio signal and a second haptic signal each generated at the first location;
logic configured to integrate the first haptic signal and the second haptic signal into an integrated haptic signal; and
logic configured to reproduce an integrated haptic image corresponding to the integrated haptic signal at the first location and the second location.

20. The system of claim 19, further comprising:
logic configured to integrate a force detected by a first haptic device that generates the first haptic signal into the integrated haptic signal; and
logic configured to integrate another force detected by a second haptic device that generates the second haptic signal into the integrated haptic signal.
